(19) United States
(12) Patent Application Publication
(10) Pub. No.: US 2023/0051329 A1
(43) Pub. Date: Feb. 16, 2023

(54) INTER-BAND CARRIER AGGREGATION BASED ON BEAM MANAGEMENT CAPABILITY

(71) Applicant: Sony Group Corporation, Tokyo (JP)

(72) Inventors: José FLORDELIS, Lund (SE); Kun ZHAO, Malmö (SE); Olof ZANDER, Södra Sandby (SE); Erik Lennart BENGTSSON, Eslöv (SE); Fredrik RUSEK, Eslöv (SE)

(21) Appl. No.: 17/790,746

(22) PCT Filed: Dec. 18, 2020
(86) PCT No.: PCT/EP2020/086963

§ 371 Date: Jul. 4, 2022

(30) Foreign Application Priority Data
Jan. 17, 2020 (SE) 2050041-9

(51) Int. Cl. H04W 72/04; H04L 5/00

(52) U.S. Cl. CPC H04W 72/046; H04L 5/001; H04W 72/0453

(57) ABSTRACT

A method carried out in a User Equipment, UE, (1) for establishing communication with a wireless network (100) using inter-band Carrier Aggregation, CA, comprising: transmitting (610), to the wireless network, information identifying capabilities (51) of the UE to perform beam management of multiple Component Carriers, CC; receiving (612), from a base station (110) of the wireless network, dependent on the capabilities, information (52) indicative of co-location properties of a first CC in a first band and a second CC in a second band; establishing (617) communication between the UE (1) and the wireless network (100) using the first and the second CC.

### TECHNICAL FIELD

This disclosure relates to methods and devices for establishing communication with a wireless network using inter-band Carrier Aggregation. More specifically, solutions are provided for identification of terminal capabilities for improving the establishment of communication.

### BACKGROUND

Radio communication systems operating under various iterations of the 3rd Generation Partnership Project (3GPP) offer high peak data rates, low latency, improved system capacity, and low operating cost resulting from simple network architecture. These include inter alia Long-Term Evolution (LTE) system and more recently so called 5G networks and New Radio (NR). Orthogonal frequency division multiplexing (OFDM) radio technology has been incorporated to enable high data bandwidth to be transmitted efficiently while still providing a high degree of resilience to reflections and interference. In such radio communication systems, the transmit power of each wireless terminal, also referred to as User Equipment (UE), needs to be maintained at a certain level and regulated by the network. A base station, or access node, of a 5G wireless network is referred to as a gNB. The actual point of transmission and reception of the base station is herein referred to as a Transmission and Reception Point (TRP). The TRP may be seen as a network node which includes or is co-located with an antenna system of the base station.

When operating a UE in the mm Wave frequencies, such as in NR, the functionality of beamforming is essential, since it - contrary to an omnidirectional transmission - allows transmissions to be directed so that the signal to noise ratio is improved. This has become more relevant as wireless communication enters mm wave frequency ranges, e.g. FR2 including a Frequency Range of 24250-52600 MHz, at which spatial filters and antennas may be employed for transmission in finer cone angles. However, at higher frequencies the range decreases. Network vendors have expressed interest in both co-located and non-co-located deployments of TRPs operating in inter alia the 28 GHz band and the 39 GHz band and covering the same areas. The reason is that 39 GHz and 28 GHz have different coverage properties and, therefore, denser gNB deployments will be needed for 39 GHz compared to 28 GHz.

FIGS. 1A and 1B illustrate a possible deployment scenario of TRPs 10-13. At the respective TRP, a larger box indicates 28 GHz TRP and a smaller box indicates a 39 GHz TRP. For example, TRP 10 includes co-located TRP 10A for 28 GHz and TRP 10B for 39 GHz. A similar co-location is provided for TRPs 12 and 13. FIG. 1A illustrates the coverage from the respective TRP at 39 GHz, whereas FIG. 1B illustrates the coverage from the respective TRP at 28 GHz. Due to the poorer coverage at the higher frequency, one additional base station at TRP 11 is needed for 39 GHz in order to cover an area in the middle.

However, such a deployment also leads to a more complicated beam management for inter-band Carrier Aggregation (CA) operation, especially when the band separation is as large as 11 GHz. Improvements are thus needed in the art of inter-band CA, in particular when TRPs of the different bands may be either co-located or not.

### SUMMARY

Solutions to meet the aforementioned need for improvement are provided in the independent claims, whereas advantageous embodiments are set out in the dependent claims.

According to one aspect, a method is provided which is carried out in a UE for establishing communication with a wireless network using inter-band CA. The method comprises:
transmitting, to the wireless network, information identifying capabilities of the UE to perform beam management of multiple CCs;
receiving, from a base station of the wireless network, dependent on the capabilities, information indicative of co-location properties of a first CC in a first band and a second CC in a second band;
establishing communication between the UE 1 and the wireless network using the first and the second CC.

A corresponding solution is provided for a base station of a wireless network for establishing communication with a UE using inter-band CA, comprising:
obtaining information identifying capabilities of the UE to perform beam management of multiple Component Carriers, CC;
transmitting, dependent on the capabilities, information to the UE, wherein said information is indicative of co-location properties of a first CC in a first band and a second CC in a second band;
establishing communication on the first and the second CC.

The proposed methods provide for reduced signaling overhead, inter alia in the sense that the network is configured to provide relevant data to the UE for inter-band CA, based on its level of capability in this respect. The proposed solution further provides for the network to provide suitable allocation of TRPs based on the implementation of the UE, as reflected by the capabilities with regard to CA.

### BRIEF DESCRIPTION OF THE DRAWINGS

FIGS. 1A and 1B schematically illustrate deployment of TRPs for coverage at different mm wave bands of a wireless network.

FIG. 1C schematically illustrates beams usable for communication between UEs and various TRPs of the wireless network.

FIG. 2 schematically illustrates a wireless network and communication between a UE and various base stations using CA according to various embodiments.

FIG. 3 schematically illustrates a UE configured to operate according to various embodiments.

FIG. 4 schematically illustrates a base station configured to operate according to various embodiments.

FIG. 5 schematically illustrates a signaling diagram between the wireless network and a UE for establishing communication using inter-band CA according to various embodiments.

FIG. 6 schematically illustrates a flow chart of a method carried out in a UE according to various embodiments, for establishing communication using inter-band CA.

FIG. 7 schematically illustrates a flow chart of a method carried out in a base station according to various embodiments, for establishing communication using inter-band CA.

### DETAILED DESCRIPTION

In the following description, for purposes of explanation and not limitation, details are set forth herein related to various embodiments. However, it will be apparent to those skilled in the art that the present invention may be practiced in other embodiments that depart from these specific details. In some instances, detailed descriptions of well-known devices, circuits, and methods are omitted so as not to obscure the description of the present invention with unnecessary detail. The functions of the various elements including functional blocks, including but not limited to those labeled or described as “computer”, “processor” or “controller”, may be provided through the use of hardware such as circuit hardware and/or hardware capable of executing software in the form of coded instructions stored on computer readable medium. Thus, such functions and illustrated functional blocks are to be understood as being either hardware-implemented and/or computer-implemented and are thus machine-implemented. In terms of hardware implementation, the functional blocks may include or encompass, without limitation, digital signal processor (DSP) hardware, reduced instruction set processor, hardware (e.g., digital or analog) circuitry including but not limited to application specific integrated circuit(s) [ASIC], and (where appropriate) state machines capable of performing such functions. In terms of computer implementation, a computer is generally understood to comprise one or more processors or one or more controllers, and the terms computer and processor and controller may be employed interchangeably herein. When provided by a computer or processor or controller, the functions may be provided by a single dedicated computer or processor or controller, by a single shared computer or processor or controller, or by a plurality of individual computers or processors or controllers, some of which may be shared or distributed. Moreover, use of the term “processor” or “controller” shall also be construed to refer to other hardware capable of performing such functions and/or executing software, such as the example hardware recited above.

The drawings are to be regarded as being schematic representations and elements illustrated in the drawings are not necessarily shown to scale. Rather, the various elements are represented such that their function and general purpose become apparent to a person skilled in the art. Any connection or coupling between functional blocks, devices, components, or other physical or functional units shown in the drawings or described herein may also be implemented by an indirect connection or coupling. A coupling between components may also be established over a wireless connection. Functional blocks may be implemented in hardware, firmware, software, or a combination thereof.

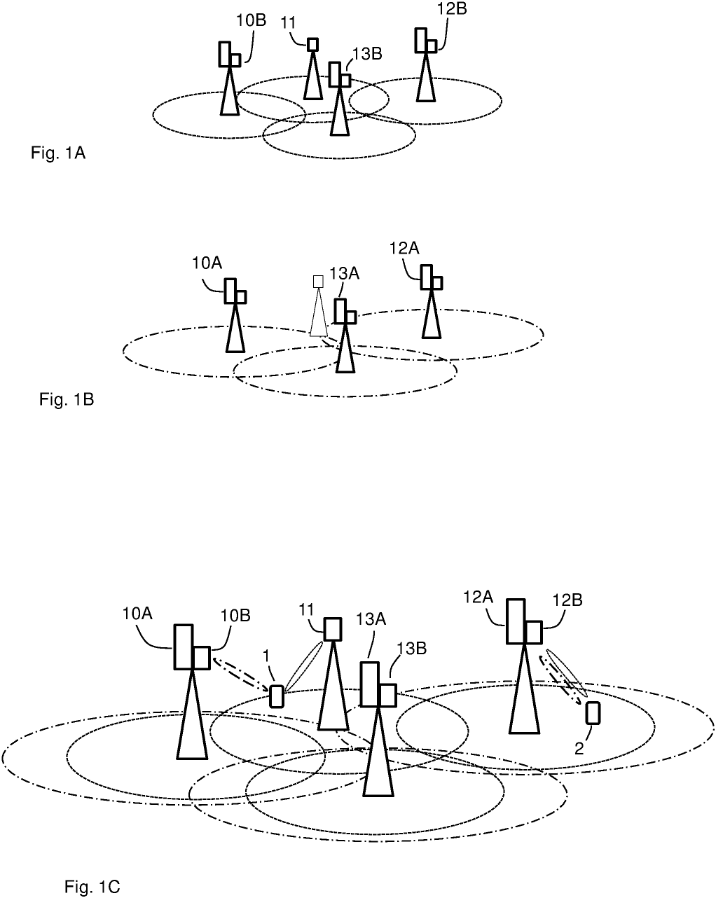

As indicated, beam management is a complicated procedure in inter-band CA since the UE capabilities and network deployments must be very flexible for inter band CA to function. UEs capable of inter-band CA may benefit from deployments as illustrated in FIGS. 1A and 1B. However, whether a particular UE is capable of simultaneously receiving and/or transmitting data on both bands will depend on the UE’s RF architecture, which is up to the UE vendor. Depending on the level of UE support, one can foresee different scenarios for inter-band carrier aggregation. Some scenarios are being discussed in the time frame of Rel. 17, and further scenarios are likely to be proposed in future releases. This is indicated in table 1 below, which indicates capability of inter-band CA with co-located and non-co-located TRP deployment, according to beam management (BM) support by UE RF architecture. Combinations marked with (*) may be considered more likely. In the table, (partially) capable means (partially) supported by the relevant UE RF architecture.

Table 1

| | | | |
|---|---|---|---|
| | | Co-located TRPs | Non-co-located TRPs |
| Independent BM | Mainly overlapping spherical coverage | Capable (*) | Partially capable |
| | Mainly non-overlapping spherical coverage | Partially capable | Capable (*) |
| Aligned, non-independent BM | | Capable | Not capable |
| Non-aligned, non-independent BM | | Not capable | Not capable |

Here, independent BM means that the UE is capable of simultaneously transmitting and/or receiving on multiple Component Carriers (CC) using arbitrary beams, or spatial filters, on each CC. Such a capability requires the UE to have at least two groups of independent phase shifters, which results in a better beam management flexibility but also in higher power consumption.

FIG. 1C illustrates two UEs, 1 and 2, in the wireless network deployment as indicated in FIGS. 1A and 1B. A UE RF architecture might be such that roughly the same transmit/receive directions are available on multiple CCs, and that the spherical coverages of the CCs mainly overlap. This is illustrated by UE 2 in FIG. 1C. Typically, such a UE architecture is well-suited for deployments with co-located TRPs, such as TRPs 12A and 12B, wherein signals propagate in similar directions. Performance with non-co-located TRPs depends on other factors such as the density of the TRP deployment and the spherical coverage percentile. A UE RF architecture may alternatively be such that the set of overlapping directions is very reduced, and the spherical coverages of the CCs are mainly non-overlapping, as indicated for UE 1 in FIG. 1C. Normally, such a UE architecture works well in non-co-located TRP deployments where signals propagate through distinct directions, but less so for co-located TRPs.

Non-independent BM means that the UE only has one fully controllable set of phase shifters over the whole frequency range of the CA. Therefore, it can only transmit and/or receive on multiple CCs using beams that point in similar directions (aligned, non-independent BM), or beams that point in different directions fixed with respect to each other (non-aligned, non-independent BM). In other words, once the UE beam direction of one band is selected, the beam direction for the other band will be fixed with respect to the first band. Such configuration is legacy from the current commercial phones in FR2. Because there is only one degree of freedom to control the direction of the beams on multiple CCs, such UE architectures can only be expected to work well when beams on multiple CCs are aligned and TRPs are co-located.

In previous releases of standards outlining technical specifications for CA, the UE is able to signal to the network whether it is capable or not of inter-band CA, in the bands of interest. This information may be conveyed as UE radio capabilities, or an ID representing such UE radio capabilities as described above, transmitted from the UE to the network when registering. This may lead to situations where the network attempts to establish a connection using inter-band CA that may in fact not work for the UE. Given an actual deployment, with either co-located or non-co-located TRPs, the lack of a priori knowledge as to whether or not inter-band CA will work for a certain UE may thus lead to signaling overhead.

For these reasons, the solutions proposed herein serve to improve establishment of communication using inter-band CA. This involves the notion of conveying information from the UE to the wireless network, identifying capabilities of the UE to perform beam management of multiple CC, thus informing the network of which level of inter-band CA support it is capable of.

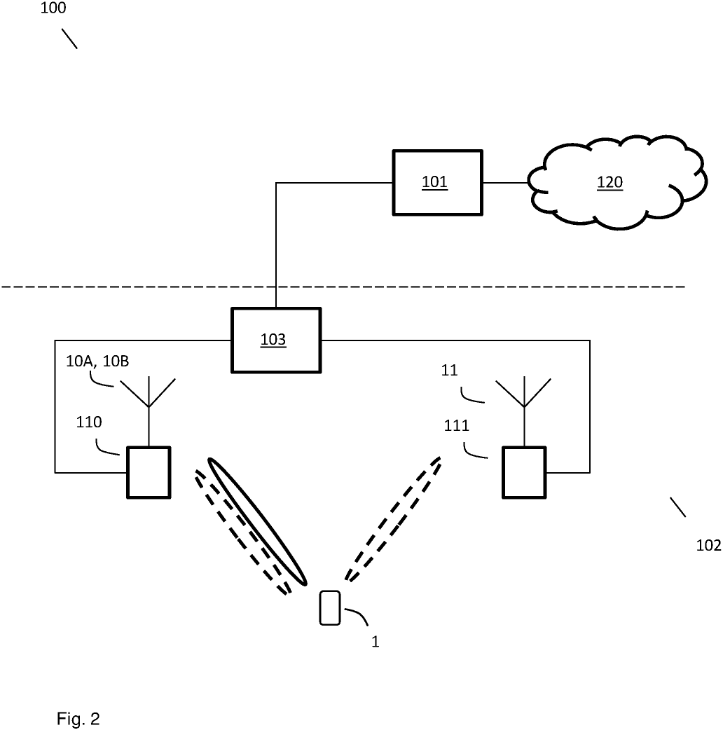

FIG. 2 schematically illustrates a wireless communication system including a wireless network 100, and a UE (or terminal) 1 configured to wirelessly communicate with the wireless network 100. The wireless network may be a radio communication network operating under general and specific regulations and limits published by the 3GPP, such as a New Radio (NR) network which may operate under FR 2, in different mm wave frequency bands. The wireless network 100 may include a core network 101, which is connected to other networks 120, such as the Internet. The wireless network 100 further includes an access network 102, which comprises a plurality of base stations or access nodes 110, 111. A base station is an entity executing the wireless connection with UEs. As such, each base station 110, 111 comprises or is connected to a transmission point TRP 10, 11, including an antenna arrangement for transmitting and receiving radio signals. The base station(s) 110, 111 may be a gNB and be configured for beamforming as introduced for 5G. The drawing further illustrates a network node 103, which may incorporate a function for managing communication with and cooperation of the base stations 110, 111, such as a user plane function. In various embodiments, a logical communication interface may be provided between the base stations 110, 111.

The UE 1 may be any device operable to wirelessly communicate with the network 100 through the base station 110, 111, such as a mobile telephone, computer, tablet, a M2M device or other. The UE 1 is configured to communicate in more than one beam, which are preferably orthogonal in terms of coding and/or frequency division and/or time division. Configuration of beams in the UE 1 may be realized by using an antenna array configured to provide an anisotropic sensitivity profile to transmit radio signals in a particular transmit direction.

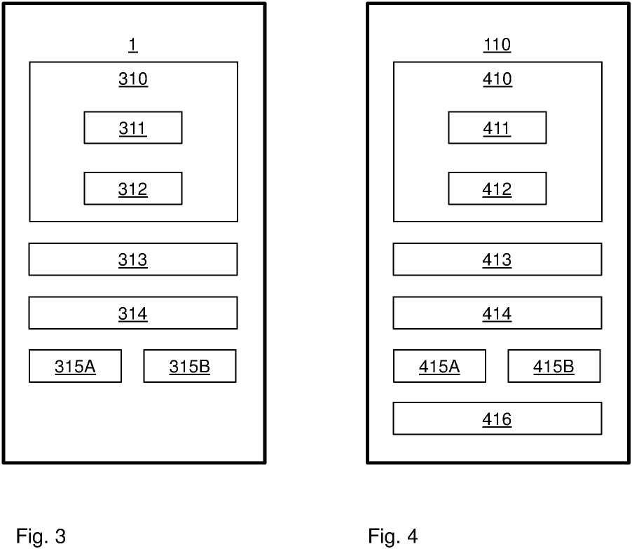

FIG. 3 schematically illustrates an embodiment of the UE 1 for use in a wireless network 100 as presented herein, and for carrying out the method steps as outlined.

The UE 1 may comprise a radio transceiver 313 for communicating with other entities of the radio communication network 100, such as the base stations 110, 111, in different mm wave frequency bands. The transceiver 313 may thus include a radio receiver and transmitter for communicating through at least an air interface.

The UE 1 further comprises logic 310 configured to communicate data, via the radio transceiver, on a radio channel, to the wireless communication network 100 and possibly directly with another terminal by Device-to Device (D2D) communication.

The logic 310 may include a processing device 311, including one or multiple processors, microprocessors, data processors, co-processors, and/or some other type of component that interprets and/or executes instructions and/or data. Processing device 311 may be implemented as hardware (e.g., a microprocessor, etc.) or a combination of hardware and software (e.g., a system-on-chip (SoC), an application-specific integrated circuit (ASIC), etc.). The processing device 311 may be configured to perform one or multiple operations based on an operating system and/or various applications or programs.

The logic 310 may further include memory storage 312, which may include one or multiple memories and/or one or multiple other types of storage mediums. For example, memory storage 312 may include a random access memory (RAM), a dynamic random access memory (DRAM), a cache, a read only memory (ROM), a programmable read only memory (PROM), flash memory, and/or some other type of memory. Memory storage 312 may include a hard disk (e.g., a magnetic disk, an optical disk, a magnetooptic disk, a solid state disk, etc.).

The memory storage 312 is configured for holding computer program code, which may be executed by the processing device 311, wherein the logic 310 is configured to control the UE 1 to carry out any of the method steps as provided herein. Software defined by said computer program code may include an application or a program that provides a function and/or a process. The software may include device firmware, an operating system (OS), or a variety of applications that may execute in the logic 310.

The UE 1 may further comprise an antenna 314, which may include an antenna array. The logic 310 may further be configured to control the radio transceiver to employ an anisotropic sensitivity profile of the antenna array to transmit radio signals in a particular transmit direction. In various embodiments, this may involve applying a transmit spatial filter 315A for adapting inter alia the spatial sensitivity of the antenna 314 in UL transmission, and a receive spatial filter 315B for adapting inter alia the spatial sensitivity of the antenna 314 in DL reception. Dependent on implementation, the spatial filters 315A, 315B may comprise plural groups of phase shifters, which may be independent, allowing for simultaneous transmission and/or reception on multiple CCs using arbitrary beams on each CC during CA.

Obviously, the terminal may include other features and elements than those shown in the drawing or described herein, such as a power supply, a casing, a user interface, one or more sensors, such as a proximity sensor, accelerometer, magnetometer, etc., configured to sense and detect orientation or proximity to another object, such as a user of the UE 1, etc.

FIG. 4 schematically illustrates a base station 110 for use in a radio communication network 100 as presented herein, and for carrying out the method steps as outlined herein. It shall be noted that the embodiment of FIG. 4 may equally well be used for the second base station 111.

The base station 110 includes or operates as a base station of a radio communication network 100, such as a gNB, configured for operation in different mm wave frequency bands. The base station 110 may comprise a radio transceiver 413 for wireless communicating with other entities of the radio communication network 100, such as the UE 1. The transceiver 413 may thus include a radio receiver and transmitter for communicating through at least an air interface.

The base station 110 further comprises logic 410 configured to communicate data, via the radio transceiver, on a radio channel, with UE 1. The logic 410 may include a processing device 411, including one or multiple processors, microprocessors, data processors, co-processors, and/or some other type of component that interprets and/or executes instructions and/or data. Processing device 411 may be implemented as hardware (e.g., a microprocessor, etc.) or a combination of hardware and software (e.g., a system-on-chip (SoC), an application-specific integrated circuit (ASIC), etc.). The processing device 411 may be configured to perform one or multiple operations based on an operating system and/or various applications or programs.

The logic 410 may further include memory storage 412, which may include one or multiple memories and/or one or multiple other types of storage mediums. For example, memory storage 412 may include a random access memory (RAM), a dynamic random access memory (DRAM), a cache, a read only memory (ROM), a programmable read only memory (PROM), flash memory, and/or some other type of memory. Memory storage 412 may include a hard disk (e.g., a magnetic disk, an optical disk, a magnetooptic disk, a solid state disk, etc.).

The memory storage 412 is configured for holding computer program code, which may be executed by the processing device 411, wherein the logic 410 is configured to control the base station 110 to carry out any of the method steps as provided herein. Software defined by said computer program code may include an application or a program that provides a function and/or a process. The software may include device firmware, an operating system (OS), or a variety of applications that may execute in the logic 410.

The base station 110 may further comprise or be connected to an antenna 414, connected to the radio transceiver 413, which antenna may include an antenna array. The logic 410 may further be configured to control the radio transceiver to employ an anisotropic sensitivity profile of the antenna array to transmit and/or receive radio signals in a particular transmit direction. In various embodiments, this may involve applying a transmit spatial filter 415A for adapting inter alia the spatial sensitivity of the antenna 414 in DL transmission, and a receive spatial filter 415B for adapting inter alia the spatial sensitivity of the antenna 414 in UL reception. The base station 110, or alternatively only the antenna 414, may form a transmission point TRP for the base station 110.

The base station 110 may further comprise a communication interface 416, operable for the base station 110 to communicate with other nodes of the wireless network 100, such as a higher network node 103 or with another base station 111.

In various embodiments, the base station 110 is configured to carry out the method steps described for execution in a base station or for controlling a TRP, as outlined herein.

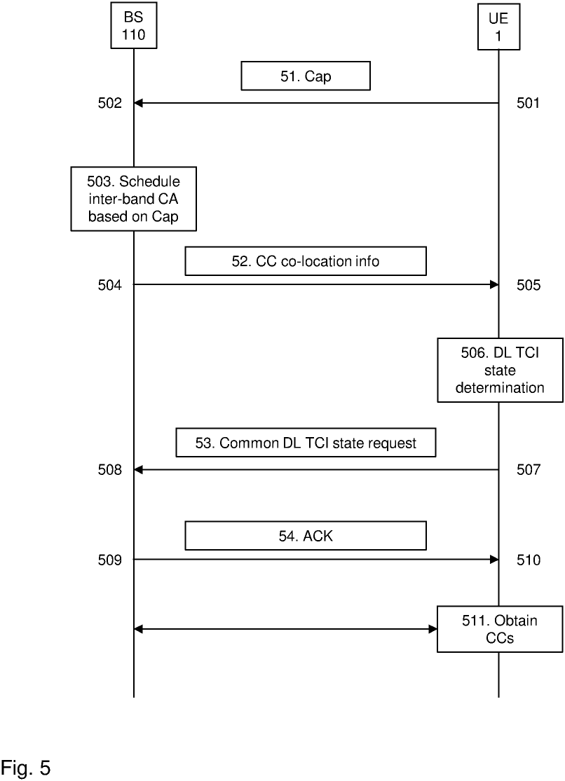

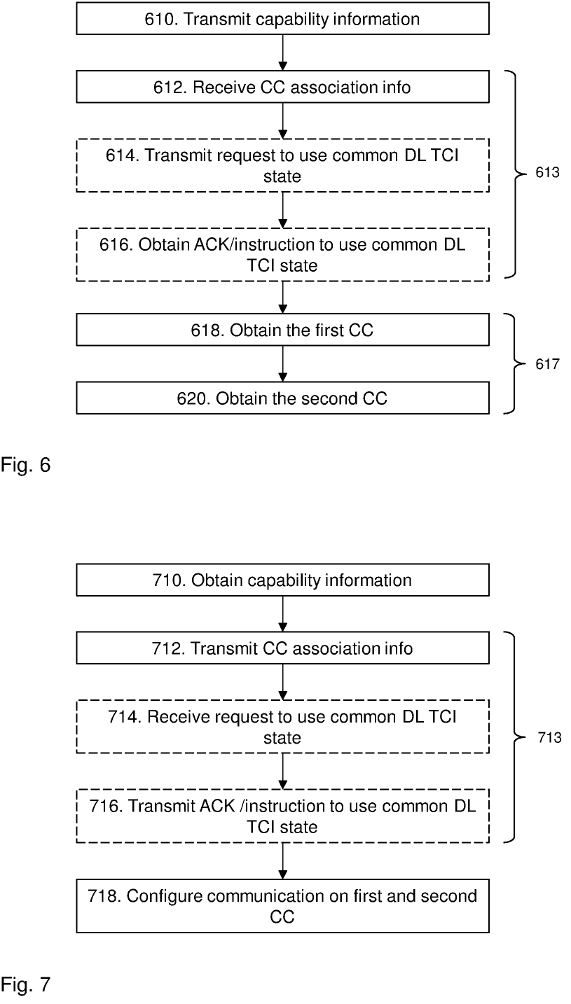

Various embodiments will now be described with reference to FIGS. 5-7. FIGS. 6 and 7 illustrate process flowcharts, whereas FIG. 5 shows a signaling diagram including at least some of the embodiments within the scope of the general methods showed in FIGS. 6 and 7.

With reference to FIG. 6, according to one aspect, a method is provided which is carried out in a UE 1 for establishing communication with a wireless network 100 using inter-band CA. The method comprises
transmitting 610, to the wireless network, information identifying capabilities 51 of the UE to perform beam management of multiple CCs;
receiving 612, from a base station 110 of the wireless network, dependent on the capabilities, information 52 indicative of co-location properties of a first CC in a first band and a second CC in a second band;
establishing 617 communication between the UE 1 and the wireless network 100 using the first and the second CC.

With reference to FIG. 7, according to another aspect, a method is provided which is carried out in a base station 110 of a wireless network 100 for establishing communication with the UE 1 using inter-band CA, comprising:
obtaining 710 information identifying capabilities of the UE to perform beam management of multiple Component Carriers, CC;
transmitting 712, dependent on the capabilities, information 52 to the UE, wherein said information is indicative of co-location properties of a first CC in a first band and a second CC in a second band;
establishing 718 communication on the first and the second CC.

The proposed methods provide for reduced signaling overhead in the sense that the network 100 is configured to provide relevant data to the UE 1 for inter-band CA, based on its level of capability in this respect. The proposed solution further provides for the network 100 to provide suitable allocation of TRPs based on the implementation of the UE 1, as reflected by the capabilities with regard to CA. Examples of implementation and embodiments will be provided in the following sections.

The information identifying capabilities 51 may be comprised in UE radio capabilities, as provided by the UE 1 to the network 100 upon registering to the network. Alternatively, the UE 1 may transmit a capability ID as said information, which identifies associated UE radio capabilities which may be obtained from a database in or connected to the network 100. Such a capability ID may e.g. be manufacturer-specific and defined by the UE manufacturer or vendor, or PLMN-specific and defined by an operator of the network 100. Various forms of defining and communicating capability IDs may carried out as provided for under the 3GPP concept of RACS (Radio Access Capability Signaling).

The capabilities 51 may in various embodiments identify the capability of communication using CA, and may specify, directly or indirectly, within which frequency bands and/or which combination of frequency bands different CCs may be supported during CA. In some embodiments, the capabilities 51 may identify the capability to perform independent beam management within a common spherical region. This may be provided in the capabilities with respect to band combinations, such as on the first and the second band.

Based on the capabilities 51 with regard to inter-band CA, the base station 110 may be configured to transmit 712 information 52 to the UE 1, which information is indicative of said co-location properties. In this respect, the information 52 may be dependent on the capabilities 51 with regard to inter-band CA, such that different information 52 is transmitted dependent of what capability with regard to inter-band CA the UE 1 has. In some embodiments, the information 52 is only transmitted responsive to the capabilities 51 indicating affirmative capability with regard inter-band CA, such as e.g. one of affirmative capability to communicate using inter-band CA on the first and the second band, affirmative capability to perform independent beam management on the first and the second band, or affirmative capability to perform independent beam management within a common spherical region on the first and the second band, or affirmative capability to perform aligned non-independent beam management on the first and the second band. For any UE implementation where one of these capabilities exist, the establishment of the inter-band CA communication may benefit from the network 100 obtaining this information of the capabilities 51.

In one example, the UE 1 is configured to signal information about its capabilities 51 to the network 100, reflecting a capability to perform independent beam management on the same coverage region, e.g., in the same spherical sector. The network 100 may thereby be configured to, for instance, allocate co-located TRPs for better inter-band CA performance and reduced signaling overhead.

In another example, the UE 1 is configured to signal information about its capabilities 51 to the network 100, reflecting a capability to perform independent beam management on different coverage regions, e.g. in antipodal spherical sectors. The network 100 may thereby be configured to allocate non-co-located TRPs for better inter-band CA performance and reduced signaling overhead.

In yet another example, the UE 1 is configured to signal information about its capabilities 51 to the network 100, reflecting a capability to perform aligned, non-independent beam management for inter-band CA on multiple CCs. The network 100 may thereby be configured to allocate co-located TRPs for better inter-band CA performance and reduced signaling overhead.

In some embodiments, the information 52 indicative of co-location properties indicates co-location of a first TRP for the first CC and a second TRP for the second CC, such as TRPs 12A and 12B. This information may in various embodiments be conveyed as a single bit, indicating colocation or not, or a combination of bits indicating more information, in DL signaling.

In some embodiments, receiving 612 information 52 indicative of co-location properties includes receiving information, from the network, identifying the frequency bands of the first CC and the second CC destined to be used for CA.

In some embodiments, receiving 612 information 52 indicative of co-location properties of a first CC in a first band and a second CC in a second band may comprise obtaining 613 an instruction to use a common DL Transmission Configuration Indicator (TCI) state for all CCs of the CA communication to be established.

In various versions of such embodiments, obtaining an instruction comprises
transmitting 614, to the base station, a request to use a common DL TCI state for all CCs, for reception 714 in the network 100; and
receiving 616 the instruction, which is transmitted 716 from the network 100, which instruction identifies approval to use the common DL TCI state. In such an embodiment the instruction may be an ACK of the request to use a common DL TCI state for all CCs.

In some embodiments, the received information 52 indicates that the DL TCI states of the CCs of the CA communication to be established are Quasi Co-Located (QCL). In a variant of this embodiment, the information 52 may provide if the QCL indication is of rank 1 or rank 2. In Line-Of-Sight (LOS) mm wave links rank 2 is often used to transmit two streams based on polarization MIMO. By including rank information in the QCL indication, the UE may be informed whether an aggregated QCL beam carries one or two polarizations.

In various embodiments, the UE 1 may thus be configured to obtain the first CC and the second CC with the same DL TCI state.

In various embodiments, the establishing 617 may comprise
determining 618 a first beam in the first band by performing a beam search; and
determining 620 a second beam the second band based on said beam search and said information.

For example, if the information 52 indicates that the first and second CC are co-located, it follows from determining the first beam in what direction the second beam shall be determined.

Referring back to the basis for the presented solutions, and with reference to drawings and the disclosure of general solutions and embodiments outlined herein, the deployment of base stations and TRPs can be either co-located and non-co-located for inter band CA. Therefore, in various embodiments, a working assumption is that independent beam management will be implemented for inter-band CA operation as a baseline.

In an exemplary embodiment based on this assumption, the base station 110, e.g. a gNB, signals, i.e. transmits 712 information 52, to the UE 1 whether TRPs 10A and 10B/11, respectively, for multiple CCs for inter-band CA (e.g., 28 and 39 GHz) are co-located or not. The aim of the signaling is inter alia to simplify the beam management for inter-band CA for co-located scenario. Additionally, or alternatively, the base station 110 signals 716 to the UE 1 that a DL TCI state common to all CCs in the CA is to be used. The latter signaling can also be initiated 614 by a UE 1 with the knowledge that TRPs for multiple CCs for inter-band CA are co-located, and desires to simplify DL TCI state management.

If the TRPs are co-located, such as 10A, 10B, and the UE 1 can support independent beam management for overlapping regions, then the UE 1 does not need to perform beam searching on all CCs. It may instead be configured to perform a beam search on one CC, and then subsequently use beams with similar spatial characteristics on the other CC(s).

If the TRPs 10A, 10B are co-located, then management of the DL TCI states can be simplified by noting that they are QCL in the information 52. By this, signaling overhead can be reduced.

If the UE 1 is unable to perform independent beam management for each CC, the base station 110 can build a communication with UE through a master CC, and the UE 1 may be configured to transmit an uplink pilot over the second CC. The base station may be configured to select a corresponding beam for the second CC based on the received uplink pilot.

With reference to FIG. 5, an exemplary signaling diagram is shown, illustrating one use case of the overall general solutions provided herein. Note that this example is provided in a simplified manner, where only one base station 110 is shown. As the skilled person will understand, in some respect the base station 110 represent the network 100, or the access network 102, i.e. at least two base stations 110 and 111.

The UE 1 notifies 501 the network 100 of its capabilities 51. This may be carried out with any base station of the network 100, which receives 502 and provides for the storing of the capabilities 51 in the network 100. The capabilities indicate that the UE 1 is capable of independent beam management for inter-band CA. The base station 110, e.g. a gNB, may use this capability notification to decide whether to schedule the UE 1 for inter-band CA or not, based on the actual deployment of the TRPs in the relevant bands.

At a certain point in time, the serving base station 110 initiates scheduling 503 of inter-band CA, using at least a first CC and a second CC. Configuration of the scheduling is carried out dependent on the obtained CA capability of the UE 1.

The base station 110 thus notifies the UE 1 that TRPs 10A, 10B in the relevant bands are co-located, by transmitting 504 information 52 indicative of co-location properties.

Based on the received 505 information 52, the UE 1 is configured to reduce signaling overhead by deciding 506 to use on common DL TCI state for the frequency bands of the CCs.

The UE 1 transmits 507 a request 53 to this effect, for receipt 508 in the base station 110.

The base station 110 grants the request 53, e.g. by transmitting an acknowledgment 54 to the UE 1.

After receiving 510 the acknowledgment, the UE 1 can obtain the CCs to establish inter-band CA with one common DL TCI state.

Various embodiments have been outlined in the foregoing, and it shall be noted that unless they are contradictory, those embodiments may be combined with each other in any constellation, including those outlined in the appended claims.

1. A method carried out in a User Equipment (UE), for establishing communication with a wireless network using inter-band Carrier Aggregation (CA), comprising:
transmitting, to the wireless network, information identifying capabilitiesof the UE to perform beam management of multiple Component Carriers (CC);
receiving, from a base station of the wireless network, dependent on the capabilities, information indicative of co-location properties of a first CC in a first band and a second CC in a second band; and
establishing communication between the UE and the wireless network-using the first and the second CC.

2. The method of claim 1, wherein the information indicative of co-location properties is received based on the capabilities indicating affirmative capability to perform independent beam management on the first and the second band.

3. The method of claim 2, wherein the information indicative of co-location properties is received based on the capabilities indicating affirmative capability to perform independent beam management within a common spherical region on the first and the second band.

4. The method of claim 1, wherein the information indicative of co-location properties is received based on the capabilities indicating affirmative capability to perform aligned non-independent beam management on the first and the second band.

5. The method of claim 1, wherein the received information indicates that the first and second CC are co-located.

6. The method of claim 1, wherein establishing comprises
determining a first beam in the first band by performing a beam search;
determining a second beam the second band based on said beam search and said information.

7. The method of claim 1,wherein the received information indicates co-location of a first transmission point (TRP), for the first CC and a second TRP for the second CC.

8. The method of claim 1,comprising
obtaining an instruction to use a common downlink (DL), Configuration Indicator (TCI), state for all CCs.

9. The method of claim 8, wherein said instruction is provided in the received information.

10. The method of claim 9, wherein the received information indicates that the DL TCI states are Quasi Co-Located (QCL).

11. The method of claim 8, wherein obtaining an instruction comprises
transmitting, to the base station, a request to use a common DL TCI state for all CCs; and
receiving the instruction, which instruction identifies approval to use the common DL TCI state.

12. The method of claim 8, wherein the first CC and the second CC are obtained with the same DL TCI state.

13. A method carried out in a base station of a wireless network for establishing communication with a User Equipment (UE), using inter-band Carrier Aggregation (CA) comprising:
obtaining information identifying capabilities of the UE to perform beam management of multiple Component Carriers (CC);
transmitting, dependent on the capabilities, information to the UE, wherein said information is indicative of co-location properties of a first CC in a first band and a second CC in a second band; and
establishing communication on the first and the second CC.

14. The method of claim 13, wherein the information indicative of co-location properties is transmitted based on the capabilities identifying affirmative capability to perform independent beam management on the first and the second band.

15. The method of claim 14, wherein the information indicative of co-location properties is transmitted based on the capabilities indicating affirmative capability to perform independent beam management within a common spherical region on the first and the second band.

16. The method of claim 13, wherein the information indicative of co-location properties is transmitted based on the capabilities indicating affirmative capability to perform aligned non-independent beam management on the first and the second band.

17. The method of claim 13, wherein the transmitted information indicates co-location of a first transmission point (TRP), the first CC and a second TRP for the second CC.

18. The method of claim 13, comprising
providing an instruction to the UE to use a common downlink (DL), Transmission Configuration Indicator (TCI), state for all CCs.

19. The method of claim 18, wherein said instruction is provided in the transmitted information.

20. (canceled)

21. (canceled)

22. A User Equipment (UE), configured to establish communication with a wireless network using inter-band Carrier Aggregation (CA) comprising logic configured to control the UE to:
transmitto the wireless network, information identifying capabilities of the UE to perform beam management of multiple Component Carriers (CC);
receive, from a base station of the wireless network, dependent on the transmitted capabilities, information indicative of co- location properties of a first CC in a first band and a second CC in a second band; and
establish communication between the UE and the wireless network-using the first and the second CC.

23. (canceled)

24. (canceled)

25. (canceled)
